(19) United States
(12) Patent Application Publication
(10) Pub. No.: US 2007/0061613 A1
(43) Pub. Date: Mar. 15, 2007

(54) Restart method for operating system

(76) Inventors: Yusuke Ohashi, Tokyo (JP); Akio Tatsumi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/274,320

(22) Filed: Nov. 16, 2005

(30) Foreign Application Priority Data
Sep. 15, 2005 (JP) 2005-267893

(51) Int. Cl. G06F 11/00

(52) U.S. Cl. 714/6

(57) ABSTRACT

A restart method for restarting an operating system in a computer in which a failure has occurred, the restart method includes the steps of, upon occurrence of a failure in an active computer in which an operating system (OS) is in operation, ordering disconnection of an OS storing storage device from the active computer by using a processor, ordering connection of the OS storing storage device to a stand-by computer by using the processor, restarting the operating system in the OS storing storage device by using the stand-by computer, and outputting dump information to a dump information storing storage device, by using the active computer, in parallel with restart of the operating system conducted by the stand-by computer.

### INCORPORATION BY REFERENCE

The present application claims priority from Japanese application JP2005-267893 filed on Sep. 15, 2005, the content of which is hereby incorporated by reference into this application.

### BACKGROUND OF THE INVENTION

The present invention relates to a restart technique for restarting an operating system in a computer in which a failure has occurred.

In general, high reliability is required of online systems. Online systems are required not to stop service. Even if the service should be stopped, online systems are demanded to shorten the service stop time. When a host included in these systems has stopped due to a failure, rapid restart and taking of a copy (dump information) of a memory for discriminating a failure cause are demanded.

In operating systems, a disk for swap is used as the disk for storing dump information in many cases. If an operating system stops in such a case, then contents of the memory are exported onto a disk as the dump information and restart is conducted. During the restart, the dump information is copied onto a disk that stores the operating system, as a file. Therefore, the operating system cannot be restarted until writing of the memory contents is completed. Furthermore, restart of the operating system is not completed until the dump information is copied onto the disk that stores the operating system.

As a method for conducting dump information taking and operating system restart asynchronously, a technique described in JP-A-2001-290678 is known. According to this conventional technique, an address translator is prepared in a CPU and a memory having a capacity that is at least twice that needed by the operating system is prepared in a host. When the operating system has stopped, a vacant region is retrieved. Memory regions are changed over, and restart is conducted. After the operating system is restarted, taking of the dump information is conducted.

In the above-described method using the conventional technique for conducting taking of the dump information and restart of the operating system asynchronously, the address translator is incorporated into a route of memory access demanded to conduct fast data transfer. Therefore, attention is not paid to the performance. This results in a problem that the basic performance of the host is degraded. In addition, a dedicated address translator is required within the CPU or between the CPU and the memory. Therefore, attention is not paid to use in a blade formed by combining commodity components. This results in a problem that the method cannot be applied to a commodity blade.

### SUMMARY OF THE INVENTION

An object of the present invention is to provide a technique capable of solving the above-described problems and restarting an operating system without waiting for termination of taking processing of dump information when a failure has occurred in a computer during operation.

When a failure has occurred, in a fast restart system for restarting an operating system in a computer in which a failure has occurred according to the present invention, an OS storing storage device of an active computer is connected to a stand-by computer, and the operating system is restarted. In addition, dump information is output to a dump information storing storage device by the active computer.

According to the present invention, an OS disk (an OS storing storage device) for storing an operating system and a swap disk (a dump information storing device) for storing dump information are prepared separately. When a blade (active computer) including a CPU and a memory connected to the OS disk has stopped due to a failure, the OS disk is disconnected from the active blade, and connected to a different stand-by blade (stand-by computer), and the operating system is restarted. In addition, dump information in the active blade in which the failure has occurred is output to the swap disk.

The stand-by blade restarts the operating system without waiting for output completion of the dump information in the active blade. Therefore, restart of the operating system can be conducted fast.

In the case where connections between the blades and the OS disk and swap disks share the same transmission path, a band used between the active blade which has stopped and a swap disk is narrowed and a band used between the stand-by blade and the OS disk is widened. As a result, restart of the operating system can be conducted faster.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a general configuration of a system in an embodiment;

FIG. 2 is a diagram showing a configuration example of a management table 24 in the embodiment;

FIG. 3 is a diagram showing a sequence example in the case where restart is conducted when a failure has occurred in the embodiment;

FIG. 4 is a flow chart showing a processing procedure of an active blade 30 in the embodiment;

FIG. 5 is a flow chart showing a processing procedure of a management computer 20 in the embodiment;

FIG. 6 is a diagram showing an update example of the management table 24 at the time of dump processing in the embodiment;

FIG. 7 is a diagram showing an update example of the management table 24 obtained after completion of the dump processing in the embodiment;

FIG. 8 is a diagram showing a sequence example in the case where the active blade 30 cannot send a notice of a failure in the embodiment;

FIG. 9 is a diagram showing a configuration example of a system having a plurality of swap disks for stand-by blade with respect to a single stand-by blade in the embodiment; and

FIG. 10 is a diagram showing a configuration example of a system having a large number of active blades and sharing stand-by blades in the embodiment.

### DESCRIPTION OF THE EMBODIMENTS

Hereafter, a fast restart system for fast restarting an operating system of a computer in which a failure has occurred will be described.

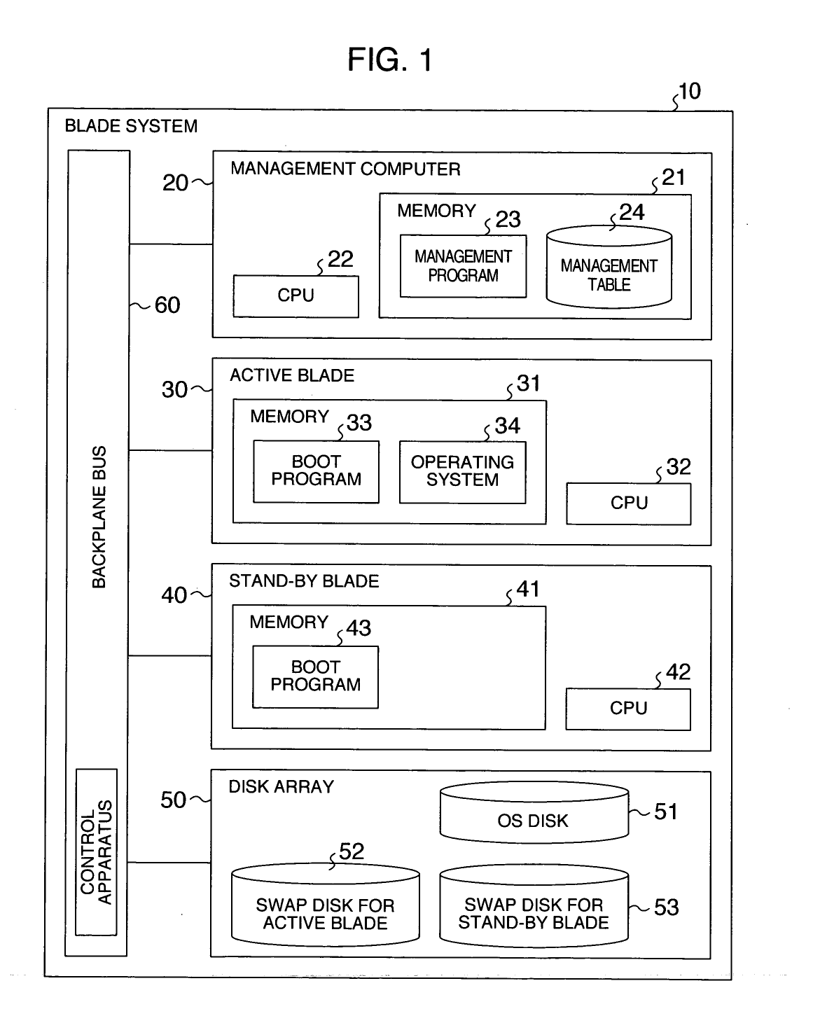

FIG. 1 is a diagram showing a general configuration of a system in an embodiment. In FIG. 1, reference numeral 10 denotes a blade system, and 20 a management computer. Reference numerals 21, 31 and 41 denote memories, and 22, 32 and 42 CPUs. Reference numeral 23 denotes a management program, 24 a management table, and 30 an active blade. Reference numerals 33 and 43 denote boot programs. Reference numeral 34 denotes an operating system, 40 a stand-by blade, 50 a disk array, 51 an OS disk, 52 a swap disk for active blade, 53 a swap disk for stand-by blade, and 60 a backplane bus.

The active blade 30 including the CPU 32 and the memory 31 is connected to the OS disk 51 and the swap disk 52 for active blade in the disk array 50. The active blade 30 is started by the boot program 33, and the operating system 34 is loaded into the memory and is being executed. The stand-by blade 40 is connected to only the swap disk 53 for stand-by blade, and an operating system is not started. The stand-by blade 40 is started by the boot program 43 as occasion demands. Disks are not mounted on the active blade 30 and the stand-by blade 40. Connections to disks in the disk array 50 are controlled by the management computer 20 and the backplane bus 60.

The management computer 20 includes the CPU 22 and the memory-21. The memory 21 stores the management program 23 and the management table 24. The management table 24 stores configuration information therein. The configuration information includes connection states between the active blade 30 and the stand-by blade 40 and the disks in the disk array 50, and the band activity ratio. The management computer 20, the active blade 30, the stand-by blade 40 and the disk array 50 are connected by the backplane bus 60. Connections and bandwidths respectively of the connections are controlled by the management program 23 in the management computer 20 and a control apparatus in the backplane bus 60.

In the blade system 10 in the present embodiment, the management program 23 in the management computer 20 is a management processing unit. If a failure has occurred in the active blade 30 in which the operating system is operating, the management processing unit orders disconnection of the OS disk 51 from the active blade 30 by using operation of the CPU 22, and orders connection of the OS disk 51 to the stand-by blade 40 by using the CPU 22. Here, the processing of the management computer 20 may be conducted by a blade by using clusterware.

The boot program 43 in the stand-by blade 40 is a boot processing unit for restarting the operating system included in the OS disk 51. The operating system 34 in the active blade 30 includes a dump processing unit for conducting output of dump information from the active blade 30 to the swap disk 52 for active blade in parallel with restart of the operating system conducted by the stand-by blade 40.

In the present embodiment, a program for causing the computer to function as the management processing unit, the boot processing unit and the dump processing unit is recorded on a recording medium such as a CD-ROM and stored on a magnetic disk or the like. Thereafter, the program is loaded into the memory and executed. By the way, the recording medium for recording the program may be another recording medium other than the CD-ROM. The program may be installed from the pertinent recording medium onto an information processing apparatus and used. Or the pertinent recording medium may be accessed via the network to use the program.

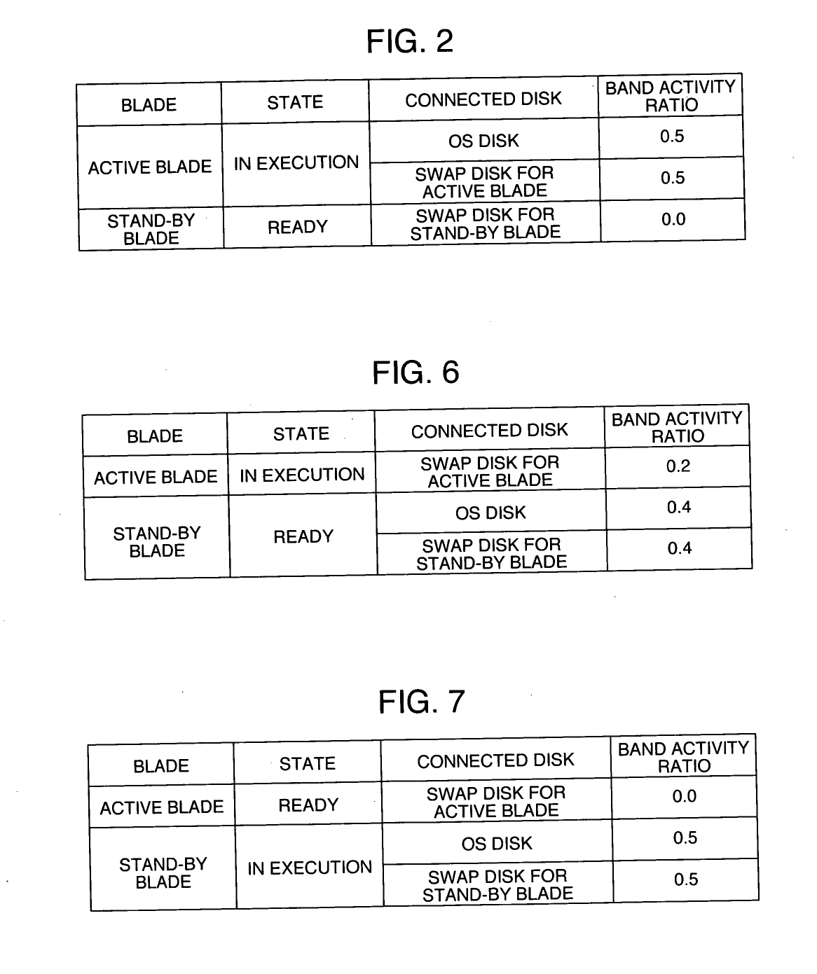

FIG. 2 is a diagram showing a configuration example of the management table 24 in the present embodiment. As shown in FIG. 2, the management table 24 in the present embodiment is a table for managing the states of the blades, connection states between the blades and the disk array, and band activity ratios of connections between the blades and the disk array. The management table 24 retains the state, connected disk and band activity ratio for each of the blades. The band activity ratio indicates a proportion of a band used between each blade and a connected disk, supposing that the whole band is “1.” The management table 24 is updated by the management computer 20.

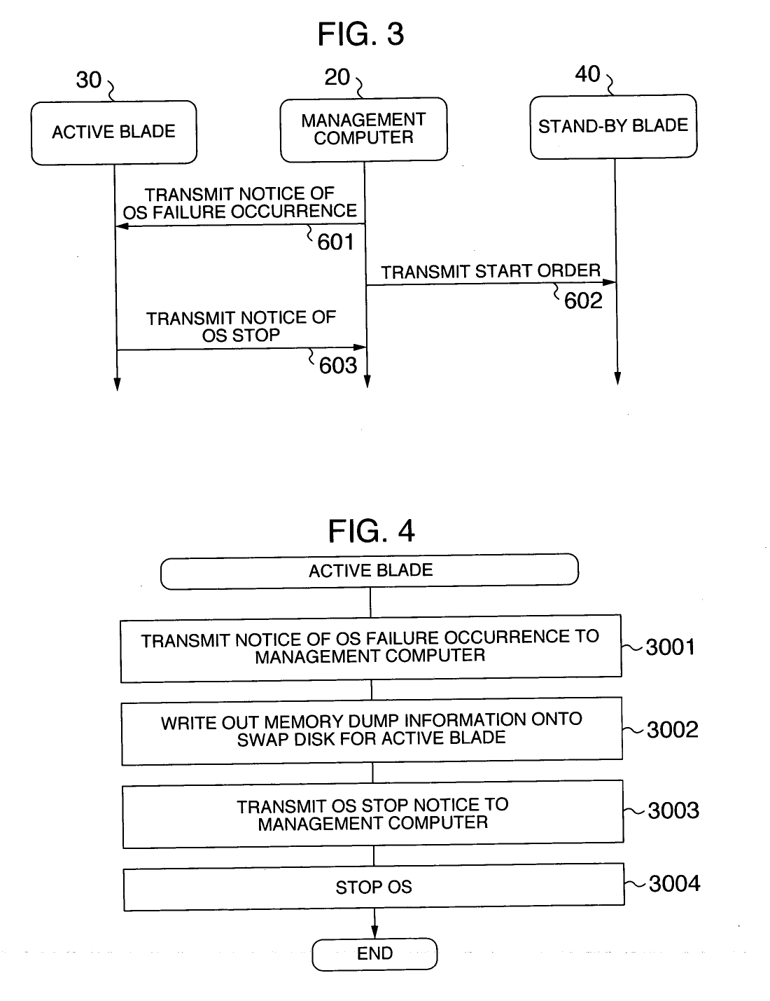

FIG. 3 is a diagram showing a sequence example in the case where restart is conducted when a failure has occurred in the present embodiment. The processing sequence shown in FIG. 3 represents how restart is conducted by the stand-by blade 40 in response to a failure in the active blade.

If an operating system failure occurs in the active blade 30, the active blade 30 transmits a notice of OS failure to the management computer 20 (sequence 601). The management computer 20 changes the configuration information so as to connect the OS disk 51 to the stand-by blade 40, and transmits a start order to the stand-by blade 40 (sequence 602). When stopping the operating system after the transmission of the notice in the sequence 601, the active blade 30 transmits a notice of OS stop (sequence 603).

FIG. 4 is a flow chart showing a processing procedure of the active blade 30 in the present embodiment. FIG. 4 shows processing operation conducted by the active blade 30 when an operating system failure has occurred, in the processing sequence described with reference to FIG. 3.

If an operating system failure has occurred, the active blade 30 transmits a notice of OS failure occurrence to the management computer 20 (step 3001). Thereafter, the active blade 30 exports dump information in the memory 31 to the swap disk 52 for active blade by using the dump processing unit (step 3002). When exporting the dump information, access to the OS disk 51 is not conducted. Even if the OS disk 51 is disconnected from the active blade 30, the dump information can be exported without a problem. If the dump information exporting is completed, the active blade 30 transmits a notice of operating system stop to the management computer 20, and stops the operating system (step 3003 and step 3004).

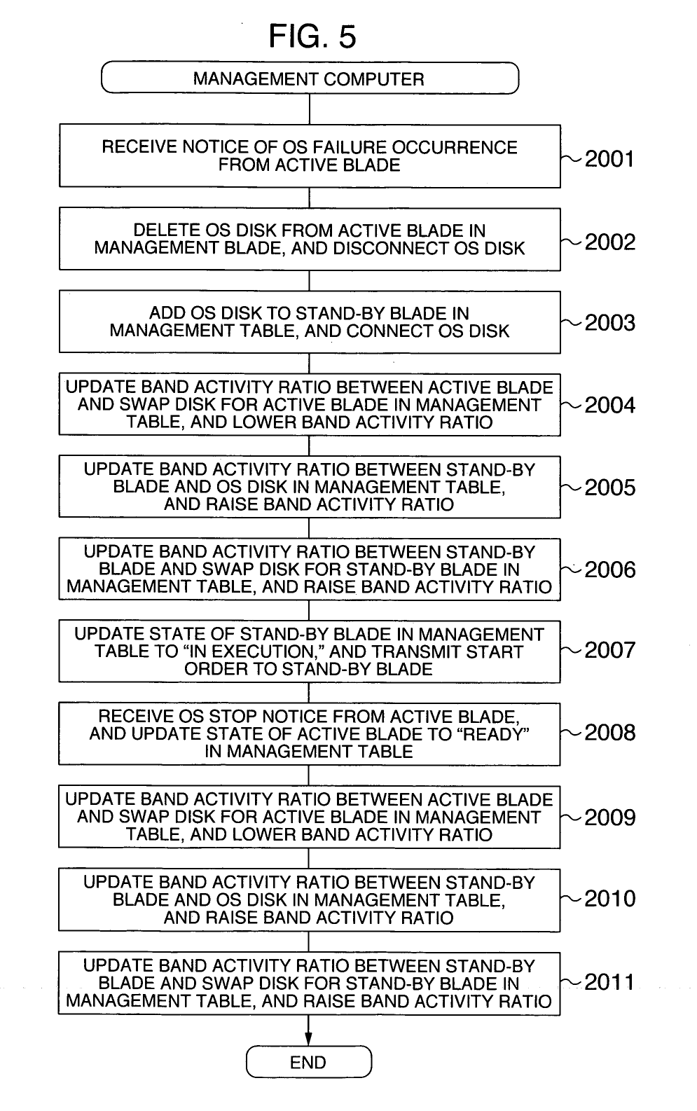

FIG. 5 is a flow chart showing a processing procedure of a management computer 20 in the present embodiment. FIG. 5 shows processing operation conducted by the management program 23 in the management computer 20 when the OS failure notice is transmitted from the active blade 30, in the processing sequence described with reference to FIG. 3.

If an operating system failure has occurred in the active blade 30, the management program 23 in the management computer 20 receives a notice of OS failure occurrence (step 2001). The OS disk 51 is not required for the dump information outputting conducted by the active blade 30. Therefore, the management computer 20 deletes the OS disk 51 from a column of the connected disk for the active blade 30 in the management table 24, and orders the backplane bus 60 to disconnect the OS disk 51 (step 2002). Upon accepting the order, the control apparatus in the backplane bus 60 disconnects the connection in the backplane bus 60 between the active blade 30 and the OS disk 51.

In order to start the stand-by blade 40, the management program 23 adds the OS disk 51 to the column of the connected disk for the stand-by blade 40 in the management table, and orders the backplane bus 60 to connect the OS disk 51 (step 2004). Upon accepting the order, the control apparatus in the backplane bus 60 establishes connection in the backplane bus 60 between the stand-by blade 40 and the OS disk 51.

Urgency is not required for the exporting of the dump information conducted by the active blade 30. On the other hand, restart conducted by the stand-by blade 40 is urgent for early restoration of service. Therefore, the management computer 20 updates the band activity ratio between the active blade 30 and the swap disk 52 for active blade in the management table 24, and orders the backplane bus 50 to lower the band activity ratio (step 2004). In order to assign a vacant band to the stand-by blade 40, the management computer 20 updates the band activity ratio between the stand-by blade 40 and the OS disk 51 and the band activity ratio between the stand-by blade 40 and the swap disk 53 for stand-by blade, and orders the backplane 60 to raise the band activity ratio (step 2005 and step 2006). As a result, the management table 24 is changed so as to cause the stand-by blade 40 to use most of the band as shown in FIG. 6.

FIG. 6 is a diagram showing an update example of the management table 24 at the time of dump processing in the present embodiment. FIG. 6 shows an update example of the management table 24 obtained when the active blade 30 outputs dump information to the swap disk 52 for active blade. Upon accepting a change order for the band activity ratio indicated in the management table 24 shown in FIG. 6, the control apparatus in the backplane bus 60 adjusts data quantities on the backplane bus 60, and exercises control so as to cause the band activity ratio between the active blade 30 and the swap disk 52 for active blade, the band activity ratio between the stand-by blade 40 and the OS disk 51, and the band activity ratio between the stand-by blade 40 and the swap disk 53 for stand-by blade to become “0.2,” “0.4” and “0.4,” respectively.

Thereafter, the control apparatus updates the state of the stand-by blade 40 in the management table 24 to “in execution,” and transmits a start order to the stand-by blade 40 (step 2007). As a result, the stand-by blade 40 is started by the boot program 43. The operating system can be re-started fast using a wider band in parallel with exporting of the dump information of the active blade 30.

On the other hand, upon completing the exporting of the dump information, the active blade 30 transmits an OS stop notice to the management computer 20. Upon receiving the OS stop notice, the management computer 20 updates the state of the active blade in the management table 24 to “ready” (step 2008). The management computer 20 updates the band activity ratio between the active blade 30 and the swap disk 52 for active blade in the management table 24, and orders the backplane bus 60 to lower the band activity ratio. The management computer 20 updates the band activity ratio between the stand-by blade 40 and the OS disk 51 and the band activity ratio between the stand-by blade 40 and the swap disk 53 for stand-by blade, and orders the backplane bus 60 to raise the band activity ratio (step 2009, step 2010 and step 2011). As a result, the management table 24 indicates that the stand-by blade uses the whole band as shown in FIG. 7.

FIG. 7 is a diagram showing an update example of the management table 24 obtained after completion of the dump processing in the present embodiment. FIG. 7 shows an update example of the management table 24 obtained after the active blade 30 has completed outputting of the dump information to the swap disk 52 for active blade. Upon accepting a change order for the band activity ratio indicated in the management table 24 shown in FIG. 7, the control apparatus in the backplane bus 60 adjusts data quantities on the backplane bus 60, and exercises control so as to cause the band activity ratio between the active blade 30 and the swap disk 52 for active blade, the band activity ratio between the stand-by blade 40 and the OS disk 51, and the band activity ratio between the stand-by blade 40 and the swap disk 53 for stand-by blade to become “0.0,” “0.5” and “0.5,” respectively.

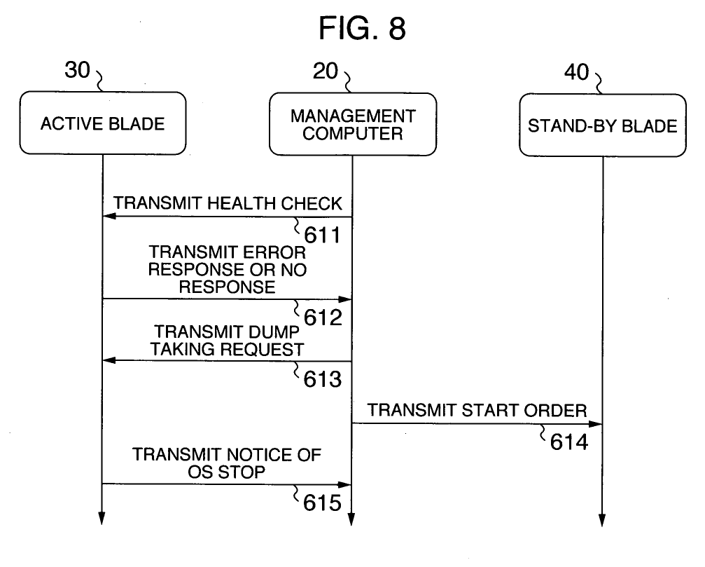

FIG. 8 is a diagram showing a sequence example in the case where the active blade 30 cannot send a notice of a failure in the present embodiment. The processing sequence shown in FIG. 8 represents how restart is conducted by the stand-by blade 40 in the case where the active blade 30 cannot send a failure notice itself.

The management computer 20 transmits a health check to the active blade 30 periodically (sequence 611). If the active blade 30 has transmitted an error response, or a response is not transmitted, the management computer 20 transmits a request to the active blade 30 to request the active blade 30 to stop the OS and pick the dump information (sequence 612 and sequence 613).

The management computer 20 changes the configuration information so as to connect the OS disk 51 to the stand-by blade 40, and transmits a start order to the stand-by blade 40 (sequence 614). When stopping the operating system, the active blade 30 transmits a notice of OS stop to the management computer 20 (sequence 615). In this way, the fast restart method in the present embodiment can be applied to even a system including a blade that cannot send a failure notice itself.

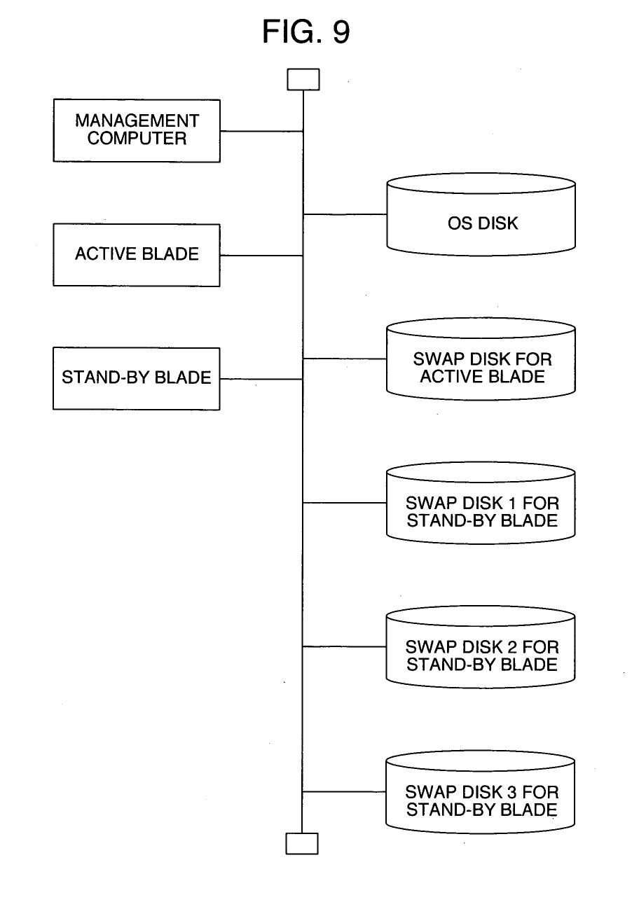

FIG. 9 is a diagram showing a configuration example of a system having a plurality of swap disks for stand-by blade with respect to a single stand-by blade in the present embodiment. Each time a failure occurs in the active blade and the operating system is restarted by the stand-by blade, a new swap disk for stand-by blade is used in this configuration. As a result, fast restart can be conducted without losing dump information. In the fast restart method in the present embodiment, the configuration of blades and disks can be changed freely. Therefore, the fast restart method can be applied to such a configuration as well.

If a failure occurs in the active blade in the configuration shown in FIG. 9, an OS disk and a swap disk 1 for stand-by blade are connected to the stand-by blade, and the operating system is restarted. Thereafter, the stand-by blade is used as an active blade. The active blade in which a failure has occurred is used as a stand-by blade after completion of dumping. If a failure has occurred in the active blade in such operation, the OS disk and a swap disk 2 for stand-by blade are connected to the stand-by blade, and the operating system is restarted. At this time, dump information for the first failure is output to a swap disk for active blade, and dump information for the next failure is output to a swap disk 1 for stand-by blade. Even if failures should occur consecutively, therefore, fast restart can be conducted without losing dump information. Alternatively, information indicating whether dump information is stored in a swap disk may be managed by the management computer, and a swap disk to be connected to the stand-by blade may be determined on the basis of the information.

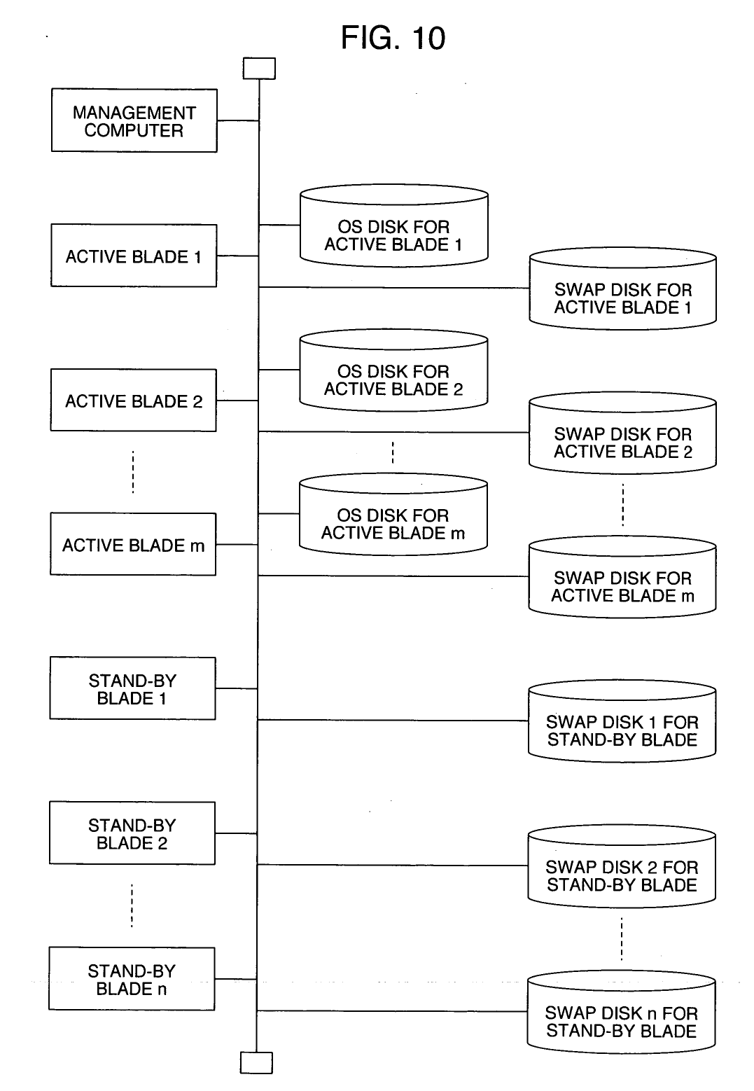

FIG. 10 is a diagram showing a configuration example of a system having a large number of active blades and sharing stand-by blades in the present embodiment. Even if a failure occurs in any active blade in this configuration, it is possible to conduct fast restart by using an unused stand-by blade. In the fast restart method of the present embodiment, connections in the backplane bus can be established freely by the management computer. The fast restart method can be applied to such a configuration as well.

When a failure has occurred, the OS storing storage device in the active computer is connected to the stand-by computer and the operating system is started and in addition damp information is output to the dump information storing storage device by the active computer, as heretofore described according to the fast restart system in the present embodiment. If a failure has occurred in the active computer in operation, therefore, it is possible to restart the operating system without waiting for taking of the dump information.

If a failure has occurred in the active computer in operation, it is possible according to the present invention to restart the operating system without waiting for taking of the dump information.

It should be further understood by those skilled in the art that although the foregoing description has been made on embodiments of the invention, the invention is not limited thereto and various changes and modifications may be made without departing from the spirit of the invention and the scope of the appended claims.

1. A restart method for restarting an operating system in a computer in which a failure has occurred, the restart method comprising the steps of:
upon occurrence of a failure in an active computer in which an operating system (OS) is in operation, ordering disconnection of an OS storing storage device from the active computer by using a processor;
ordering connection of the OS storing storage device to a stand-by computer by using the processor;
restarting the operating system in the OS storing storage device by using the stand-by computer; and
outputting dump information to a dump information storing storage device, by using the active computer, in parallel with restart of the operating system performed by the stand-by computer.

2. A restart method according to claim 1, wherein connection between the active computer and the OS storing storage device and the dump information storage device, and connection between the stand-by computer and the OS storing storage device and the dump information storing storage device are conducted by sharing an identical transmission path.

3. A restart method according to claim 1, wherein when outputting the dump information to the dump information storing storage device, by using the active computer, a band used between the active computer and the dump information storing storage device is narrowed.

4. A restart method according to claim 1, wherein when outputting the dump information to the dump information storing storage device, by using the active computer, a band used between the stand-by computer and the OS storing storage device and a band used between the stand-by computer and the dump information storing storage device are widened.

5. A restart method according to claim 1, wherein after completion of outputting of the dump information to the dump information storing storage device performed by using the active computer, a band used between the active computer and the dump information storing storage device is added to a band used between the stand-by computer and the OS storing storage device and a band used between the stand-by computer and the dump information storing storage device.

6. A restart method according to claim 1, wherein each time a failure occurs in the active computer, a dump information storing storage device which is included in a plurality of storage devices for storing dump information and to which dump information is not output is connected to the stand-by computer, and the operating system is restarted.

7. A restart method according to claim 1, wherein if a failure has occurred in any of a plurality of active computers, the operating system is restarted using any stand-by computer included in a plurality of stand-by computers.

8. A restart system for restarting an operating system in a computer in which a failure has occurred, the restart system comprising:
a management processing unit responsive to occurrence of a failure in an active computer in which an operating system (OS) is in operation, for ordering disconnection of an OS storing storage device from the active computer by using a processor and ordering connection of the OS storing storage device to a stand-by computer by using the processor;
a boot processing unit for restarting the operating system in the OS storing storage device by using the stand-by computer; and
a dump processing unit for outputting dump information to a dump information storing storage device, by using the active computer, in parallel with restart of the operating system performed by the stand-by computer.

9. A computer-executed program for causing a computer to execute a restart method for restarting an operating system in a computer in which a failure has occurred, the program causing the computer to execute the steps of:
upon occurrence of a failure in an active computer in which an operating system (OS) is in operation, ordering disconnection of an OS storing storage device from the active computer by using a processor;
ordering connection of the OS storing storage device to a stand-by computer by using the processor;
restarting the operating system in the OS storing storage device by using the stand-by computer; and
outputting dump information to a dump information storing storage device, by using the active computer, in parallel with restart of the operating system conducted by the stand-by computer.
